(19) United States
(12) Patent Application Publication
(10) Pub. No.: US 2026/0072670 A1
(43) Pub. Date: Mar. 12, 2026

(54) SYSTEM AND METHODS FOR AUTOMATIC CODE MAINTENANCE AND CODE HEALING USING GENAI

(71) Applicant: Honeywell International Inc., Charlotte, NC (US)

(72) Inventor: Gautham Sreeram Dasu, Vijayawada (IN)

(21) Appl. No.: 18/826,190

(22) Filed: Sep. 6, 2024

(51) Int. Cl. G06F 8/65; G06F 8/41; G06F 8/75

(52) U.S. Cl. CPC G06F 8/65; G06F 8/427; G06F 8/75

(57) ABSTRACT

Example techniques for code modifications are described. In an example, one or more portions of a source code that require modification are identified. Further, for each of the identified portions of the source code, a modification to be performed is identified. Furthermore, a unique identifier corresponding to each of the identified portions is generated. The unique identifier corresponds to the modification to be performed on the respective portions of the source code. Based on the unique identifier corresponding to each of the identified portions, an artificial intelligence (AI) module is selected for each of the respective portions. The selected AI module is triggered to generate a modification code to replace each of the respective portions of the source code.

### BACKGROUND

Software applications are programs designed to perform specific tasks or functions for users. The software applications are developed through a process of coding, where programmers write instructions using programming languages. These instructions tell computers how to execute various operations and respond to user input. The software applications may range from simple scripts to complex systems with millions of lines of code. The software applications may be developed by individual programmers, small teams, or large organizations, often using various development methodologies.

As the software applications expand, they may incorporate code from multiple sources, use different coding styles, and span various technologies. This diversity may make the software applications more complex, making it challenging to maintain consistency, security, and optimal performance across an entire codebase. For example, as the software applications grow more complex, they may develop vulnerabilities, loopholes, or code smells that may cause the software applications to function incorrectly or deviate from their intended purpose.

The size of modern software applications makes identifying and addressing these issues a significant challenge. This problem may be exacerbated in the software applications that rely on legacy code that cannot be easily replaced or rewritten. As the software application ages, it may become more susceptible to emerging security threats or fall out of alignment with current development best practices. This may result in suboptimal performance or increased vulnerability to exploitation.

Maintaining and enhancing existing codebases of the software applications may be crucial, as these software applications often form the foundation of critical systems and services. However, the volume and complexity of the code in the modern software applications may make manual identification and correction of all potential issues overwhelming.

Furthermore, the rapid advancement of technology and the constant evolution of security threats mean that the code once considered secure and efficient may quickly become outdated or vulnerable. This may create an ongoing requirement for organizations to keep their software applications current, secure, and functioning as intended.

### SUMMARY

The details of some embodiments of the invention described in this specification are set forth in the accompanying drawings and the description below. Other features, aspects, and advantages of the invention will become apparent from the description, the drawings, and the claims.

The present invention relates to methods, systems, and non-transitory computer-readable media for code modification.

According to an aspect of the present invention, a method for code modification includes identifying portions of a source code that require modification. The method further includes identifying, for each of the identified portions of the source code, a modification to be performed. generating a unique identifier corresponding to each of the identified portions, wherein the unique identifier corresponds to the modification to be performed on the respective portions. Furthermore, the method includes selecting, based on the unique identifier corresponding to each of the identified portions, an artificial intelligence (AI) module from amongst a plurality of AI modules for each of the respective portions. The method includes triggering the selected AI module to generate a modification code to replace each of the respective portions. In an embodiment, the method may also include receiving human feedback on the generated modification code. Further, based on the human feedback, the modification code generated by the AI module may be modified. Furthermore, the method includes replacing each of the portions of the source code with the corresponding modified code.

In accordance with an embodiment of the present invention, the system for code modification includes a code analysis engine to identify one or more portions of a source code that require modification. The code analysis engine further identifies, for each identified portion, a modification to be performed. Furthermore, the system includes a rule-based engine to generate a unique identifier corresponding to each identified portion of the source code. In an example, the unique identifier may correspond to the modification to be performed on the respective portion. The system also includes a modification engine that includes a plurality of AI modules. In an embodiment, for each identified portion of the source code, the modification engine selects an AI module from amongst the plurality of AI modules based on the unique identifier. In an example, the AI module selected by the modification engine corresponds to the modification to be performed in the identified portion of the source code. The modification engine triggers the selected AI module to generate a modification code to replace the corresponding portion of the source code.

In accordance with an embodiment of the present invention, the non-transitory computer-readable medium contains instructions that enable a processing resource to identify, for one or more portions of a source code, a modification to be performed. The processing resource is to further generate a unique identifier corresponding to each of the identified portions of the source code. In an example, the unique identifier corresponds to the modification to be performed on the respective portion of the source code. Furthermore, the processing resource assigns a priority to each of the identified portions of the source code. The processing resource selects, based on the unique identifier corresponding to each of the identified portions, an AI module from amongst a plurality of AI modules. In an example, the selected AI module corresponds to the modification to be performed on each of the identified portions of the source code. The processing resource further parses each of the identified portions of the source code in an order corresponding to the priority assigned to each of the identified portions of the source code. The processing resource triggers the selected AI module to generate a modification code for each of the parsed portions of the source code.

Embodiments of the present invention provide for an integration of code analysis, vulnerability detection, and automated workflows for modification of source codes. By automating the process from vulnerability identification to code modification, the present invention reduces manual handoffs and potential errors between stages, enabling efficient and reliable maintenance of a software application.

Also, by applying specific rules for the code modification, the present invention maintains code quality while streamlining the development process. For instance, even if an AI module suggests modifications, the system provides mechanisms for human review and adjustment within the established workflow, thereby ensuring the safety and reliability of the software application.

Additional features and advantages are realized through the concepts of the present invention. Other embodiments and aspects of the invention are described in detail herein and are considered a part of the claimed invention.

### BRIEF DESCRIPTION OF FIGURES

The following detailed description references the drawings, wherein:

FIG. 1 illustrates a network environment for implementing example techniques for code modifications, in accordance with an example implementation of the present subject matter.

FIG. 2 illustrates a system for code modification, in accordance with an example implementation of the present subject matter.

FIG. 3 illustrates the system for code modification, in accordance with another example implementation of the present subject matter.

FIG. 4 illustrates a method for code modification, in accordance with an example implementation of the present invention.

FIG. 5 illustrates the method for code modification, in accordance with another example implementation of the present invention.

FIG. 6 illustrates a flow diagram of a process for generating unique identifiers for portions of a source code identified for modification, according to an example implementation of the present subject matter.

FIG. 7 illustrates a flow diagram of a process of assigning priority to portions of the source code identified for modification, according to another example implementation of the present subject matter.

FIG. 8 illustrates a computing environment for code modification, according to an example implementation of the present invention.

In the figures, the left-most digits of a reference number identify the figure in which the reference number first appears. The same numbers are used throughout the drawings to reference like features and components.

### DETAILED DESCRIPTION

Software applications are built upon codebases, which serve as a foundation for the functionality and performance of the software applications. As the software applications evolve and adapt to changing requirements, security threats, and technological advancements, underlying codebases of the software applications may require regular refactoring and code scans to identify any shortcomings in source code of the codebases so that appropriate modifications may be made to overcome said shortcomings. In an example, the shortcomings in the source code may include any vulnerabilities present in the source code.

To identify the shortcomings in the source code, periodic scans may be performed on the codebases, for example, using static code analysis tools. In using the static code analysis tools, developers often refer to reported vulnerabilities published by global security organizations, such as the MITRE organization, that document shortcomings in publicly released software packages. When a reported vulnerability is found in the source code being analyzed, the static code analysis tool flags the vulnerability, enabling the developers to detect and address the vulnerability. However, the static code analysis tools often generate a large number of alerts, including false positives, which may overwhelm the developers and make it challenging to prioritize and address the most critical vulnerabilities efficiently.

This process of identifying shortcomings and updating the source code to address them may be tedious, cumbersome, and time-consuming for the developers, especially when dealing with legacy code written by others. The developers may need to invest significant time and effort to understand the existing codebase, identify specific areas requiring modification, and implement necessary changes. This complexity may lead to delays in addressing the vulnerabilities and may increase the risk of introducing new errors while attempting to fix existing vulnerabilities. Moreover, the manual nature of this process may result in inconsistent application of fixes across different parts of the codebase or across multiple projects within an organization.

Of late, to handle the shortcomings in the source code, tools that implement Large Language Models (LLMs) are used by developers. These tools may analyze a given source code and generate replacements for portions identified as having shortcomings. The replacement code is vetted by the developers and incorporated into the source code. However, these LLM-based tools exist as standalone systems and often lack context-specific understanding of the codebase and may generate solutions that are not fully aligned with the existing architecture or coding standards of the project.

Thus, the process of identification and addressing of shortcomings involves several entities, namely, the static code analysis tools, databases containing vulnerability reports, and LLMs, the interface between which are the developers. These entities work in isolation and there is no mechanism for them to interact with each other, resulting in a lot of manual intervention in the process of identifying the vulnerabilities and implementing the necessary modifications to the source code in respect of the identified vulnerabilities. The lack of a workflow to integrate these entities workflow not only increases the time and effort required to address the shortcomings but also introduces points of error or oversight in the code maintenance and security update process. Furthermore, this lack of workflow may lead to inconsistencies in how the vulnerabilities are addressed across different projects or teams within an organization, potentially leaving some parts of the software more vulnerable than others.

According to example implementations of the present invention, techniques for code modification that may allow for identification of vulnerabilities in a source code and modification of the source code to remove the identified vulnerabilities with minimal human interaction are described.

In accordance with example embodiments of the present subject matter, a system for code modification enables integration of various entities including vulnerability identification mechanisms, code analysis tools, and artificial intelligence (AI) modules for the generation of code modifications to remove the identified vulnerabilities, thereby creating an integrated workflow for identifying, analysing, and addressing the vulnerabilities in the source code. This helps organizations to efficiently maintain and improve their codebases, reducing the time and effort traditionally required for manual code reviews and modifications.

In an embodiment, the system queries one or more databases to access vulnerability reports that indicate source codes that may require modification. These databases may be maintained by global security organizations that report vulnerabilities discovered in publicly released software packages. The system may reference these publicly released vulnerability reports to identify vulnerabilities in the source code currently under analysis. Specifically, the system may analyse the source code with respect to reported vulnerabilities in the software packages used by the codebase, allowing the system to identify if the source code being analysed is susceptible to similar vulnerabilities. In an alternative embodiment, the system may interface with proprietary sources managed by organizations or internal vulnerability tracking systems to identify vulnerabilities in the organization's codebases.

In example embodiments, the source code may be analyzed to identify one or more portions that require modification. For each identified portion of the source code, a modification to be performed may be determined. To identify the portions of the source code that require modification and determine the modification to be performed for each identified portion, the system may implement a code analysis engine. The code analysis engine may be configured to perform periodic or triggered code maintenance activities, for example, based on the identification of vulnerabilities in the source code. The code analysis engine may scan the source code and provide detailed output regarding vulnerabilities within the source code. This output may identify a portion of the source code where the vulnerability exists, and the modification required to address the identified vulnerability.

In example embodiments, the system may generate a unique identifier corresponding to each portion of the source code identified for modification. The unique identifier may correspond to the modification to be performed on the respective portion of the source code. This process may involve assigning a distinct identifier to each specific section of the source code that has been flagged for modification by the code analysis engine. The unique identifier may serve as a reference point, linking the identified code portion with the specific modification that needs to be implemented.

In example embodiments, the system may process each identified portion of the source code requiring modification. For each portion, the system may use the assigned unique identifier to select an appropriate AI module from amongst a plurality of AI modules of the system. This selection may match the specific modification needed (as indicated by the unique identifier) with an AI module specialized for that type of code modification. The selected AI module may generate modification code designed to replace the corresponding portion of the source code.

The present invention thus integrates static code analysis tools, vulnerability report databases, and large language models (LLMs) into a unified system, with developers to serve as an interface between such discrete entities. This integration creates an automated workflow for identifying vulnerabilities, analyzing code, and generating modifications. This reduces manual effort and minimizes potential errors in code maintenance.

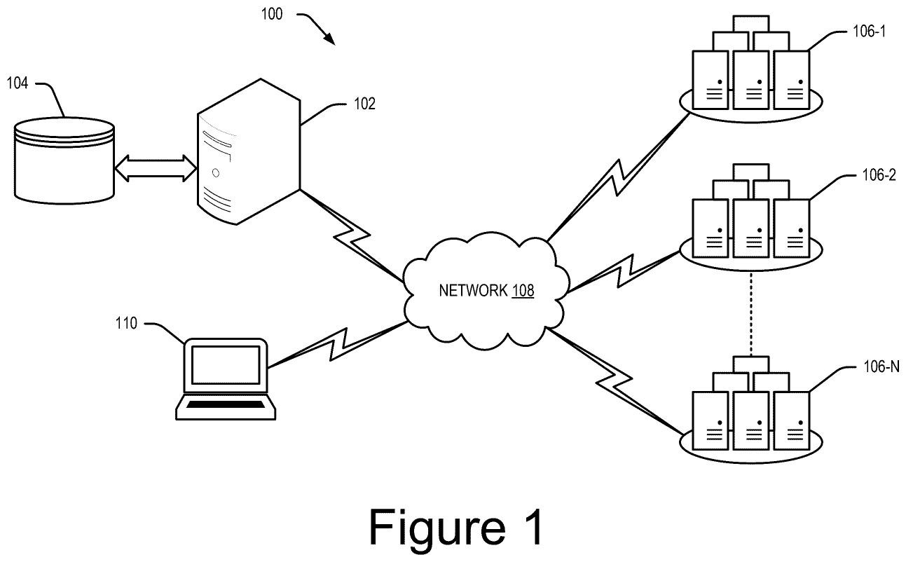

The above techniques are further described with reference to FIG. 1 to FIG. 8. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment 100 comprising a system 102 for code modification, in accordance with an example implementation of the present invention.

As explained previously, software applications are built on codebases, which contain one or more source codes that make the software applications work. As user needs change, new security risks appear, and technology improves, the source codes of the codebases may need to be modified to remove any vulnerability issues that the codebases may have or to enhance its features. As used herein, a vulnerability issue in a source code may correspond to one or more portions of the source code that may be a flaw that may be exploited, for example, by hackers, to compromise the security, functionality, or performance of the software applications. In an example, the vulnerability issues in the source code may include, but are not limited to, coding mistakes that may lead to buffer overflows, input validation issues that may result in injection attacks, improper error handling that may expose sensitive information, or outdated algorithms that may no longer provide adequate security. In some cases, the vulnerability issues may also arise from design flaws or architectural decisions that inadvertently introduce security risks or performance bottlenecks into the software applications. Therefore, identifying and modifying the source code to remove any vulnerability issue may be necessary to maintain the integrity, security, and efficiency of the software applications.

Also, the source codes may be modified or updated to enhance quality features of the software applications. In the context of the present description, enhancing quality features of the software applications may be understood as improving efficiency, readability, and usability of the source codes.

In an embodiment, identifying a vulnerability issue in a source code of a codebase of a software application may include obtaining data corresponding to reported vulnerabilities in the codebase of the software application. In an example, the codebase with respect to which the vulnerability issue is to be identified may be part of a code pipeline from amongst a plurality of code pipelines which may be stored in a dataset 104. The dataset 104 may also include details pertaining to the code pipeline, such as programming languages used in writing the source code, tech-stack artifacts, packages used in the code pipeline, other artifacts related to the source code present in a file (such as a source code file, configuration file, or build script) and how many files are present in each project. This file may be any type of file that contains or is related to the source code, including but not limited to .java, .py, .js, .xml, .json, .yaml, or .properties files, depending on the specific programming languages and technologies used in the project. The dataset 104 may be stored in a memory of the system 102 in an implementation. Implementations where the data pertaining to the code pipelines vulnerabilities obtained by the system 102 may be stored by devices other than the system 102 are also possible. Accordingly, in some examples, the dataset 104 may be stored in a memory of any other device, such as an external database server. By referencing the reported vulnerabilities, the system 102 may assess which code pipeline of the dataset 104 may potentially be affected by the reported vulnerabilities. In other words, the system 102 may assess whether the reported vulnerabilities are potentially applicable also to the source code of the codebase.

In an example, to obtain the data corresponding to the reported vulnerabilities, the system 102 may interact with one or more databases 106-1, 106-2, . . . 106-N over a network 108. In an example, the one or more databases 106-1, 106-2, . . . 106-N may include data corresponding to the reported vulnerabilities in the codebases associated with a plurality of code pipelines published by global security organizations that document shortcomings in the codebases of publicly released software packages. In an example, the one or more databases 106-1, 106-2, . . . 106-N may be publicly accessible databases, such as a Common Vulnerability and Exposure (CVE) database or the National Vulnerability Database (NVD). In an alternative embodiment, the one or more databases 106-1, 106-2, . . . 106-N may be proprietary sources maintained by organizations that develop the software applications. In an example embodiment, the one or more databases 106-1, 106-2, . . . 106-N may include at least one of the reported vulnerabilities databases and the proprietary sources discussed herein.

In an example, the network 108 may be a single network or a combination of multiple networks and may use a variety of different communication protocols. The network 108 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN). Depending on the technology, the network 108 may include various network entities, such as gateways, and routers; however, such details have been omitted for the sake of brevity of the present description.

Further, in an embodiment, the data corresponding to the reported vulnerabilities obtained by the system 102 from the one or more databases 106-1, 106-2, . . . 106-N may include, but are not limited to, details related to the vulnerability, such as severity score of the reported vulnerabilities, programming language affected by the vulnerabilities, and the like. The data related to the reported vulnerabilities may also include an identification number, e.g., CVE number, of the vulnerability, date of discovery, and affected software versions amongst other details. In an embodiment, the data pertaining to the reported vulnerabilities obtained from the one or more databases 106-1, 106-2, . . . 106-N may be recorded by the system 102 in the dataset 104.

In an embodiment, once the dataset 104 is updated with the reported vulnerabilities, the system 102 may perform a query operation to identify code pipelines that may be affected by any of the reported vulnerabilities. To accomplish this, the system 102 may incorporate one or more code analysis tools that scan each of the plurality of code pipelines in the dataset 104 to identify one or more code pipelines that incorporate software packages known to have reported vulnerabilities as obtained by the system 102 from the one or more databases 106-1, 106-2, . . . 106-N.

In an embodiment, once the code pipeline affected by the reported vulnerabilities is identified, the code analysis tools may perform a scan to identify specific portions of a source code within the codebase of the affected code pipeline that may have a vulnerability issue. After identifying these vulnerable portions of the source code, the code analysis tools may analyze the identified vulnerable portion of the source code to determine modifications required to remove the vulnerability issue. In an example, for each identified vulnerable portion of the source code, the code analysis tools may specify a modification to be performed to address the vulnerability.

In another embodiment, in addition to identifying the portions of the source code that need modification to address one or more vulnerability issues, the code analysis engine may also identify portions of the source code that may be modified to enhance the quality of the source code. In doing so, the code analysis engine may flag the portions of the source code that may benefit from improvements in efficiency, readability, and usability.

In an example, determining the modifications that may performed to improve the quality of the source code may include identifying portions of the source code that are overly complex, poorly structured, or inefficiently implemented. The code analysis engine may also highlight areas where code documentation is lacking or where naming conventions could be improved for better clarity. For each identified portion, the code analysis engine may suggest specific modifications or improvements to enhance the overall quality and robustness of the source code. These suggestions may include, but are not limited to, refactoring complex functions within the source code, optimizing the source code for better performance, improving variable naming for increased readability, or adding appropriate comments to enhance the understandability of the source code.

In some cases, a portion of the source code may include one or multiple of both types of issues, i.e., vulnerability issues and quality issues. In such scenarios, the code analysis engine may flag the portions of the source code accordingly.

Furthermore, in an embodiment, the system 102 may generate a unique identifier corresponding to each identified portion of the source code that needs to be modified. In an example, the unique identifier may correspond to the modification to be performed on the respective portion of the source code. Thus, for a portion of the source code that may have been identified to have multiple issues, multiple unique identifiers corresponding to each of the issues may be assigned to the portion.

In an embodiment, the system 102 processes each identified portion of the source code requiring modification. For each identified portion of the source code, the system 102 selects an artificial intelligence (AI) module from a plurality of AI modules (not illustrated) of the system 102 based on the unique identifier. This selection of the AI module matches the specific modification needed (as indicated by the unique identifier) with an AI module specialized for that type of code modification. For instance, in case there is identified to be a portion of source code that exposes the associated software application to a security threat, the unique identifier associated with such portion may be indicative of such a vulnerability issue. Similarly, upon analysis of the source code, if the code analysis engine assesses that a portion of the code may be modified to enhance its reusability, the unique identifier that may be associated with this portion may be indicative of a quality enhancement requirement. In some examples, the unique identifier associated with portions that need modification owing to a vulnerability may have a high priority as opposed to modification for quality enhancement. The system 102 activates the selected AI module, which generates modification code designed to replace the corresponding portion of the source code.

In an example, the system 102 may enable experts, such as software developers, to review the modification code generated by the AI module prior to deploying the modification code to replace the corresponding vulnerable portion of the source code. In an example, to review the modification code generated by the AI module, the system 102 may be accessed by the software developers through the network 108 via browsers or locally installed client applications on at least one user device 110. Examples of the user device 110 may include, but are not limited to, a desktop computer, a laptop computer, a tablet, a smartphone, a smart whiteboard, a pre-loaded tablet or smartphone, and similar devices. As shown in FIG. 1, the user device 110 may be configured to receive inputs from the software developers and communicate said inputs to the system 102, or components thereof. These inputs may include approvals, rejections, or suggestions for further modifications to the modification code generated by the AI module. In an example, the system 102 may allow multiple developers to review the modification code simultaneously.

Thus, the present subject matter provides an autonomous system that seamlessly integrates code analysis and code generation processes. This integrated approach enables the system to automatically identify vulnerabilities in the code pipelines at various stages of development, including legacy code, production code, and code under development. By leveraging the AI modules, the system may autonomously generate appropriate code fixes for the identified vulnerabilities and enhancements, minimizing the need for human intervention. This intelligent pipeline not only enhances the efficiency of the source code but also reduces the time and resources typically required for manual review of the source code and remediation.

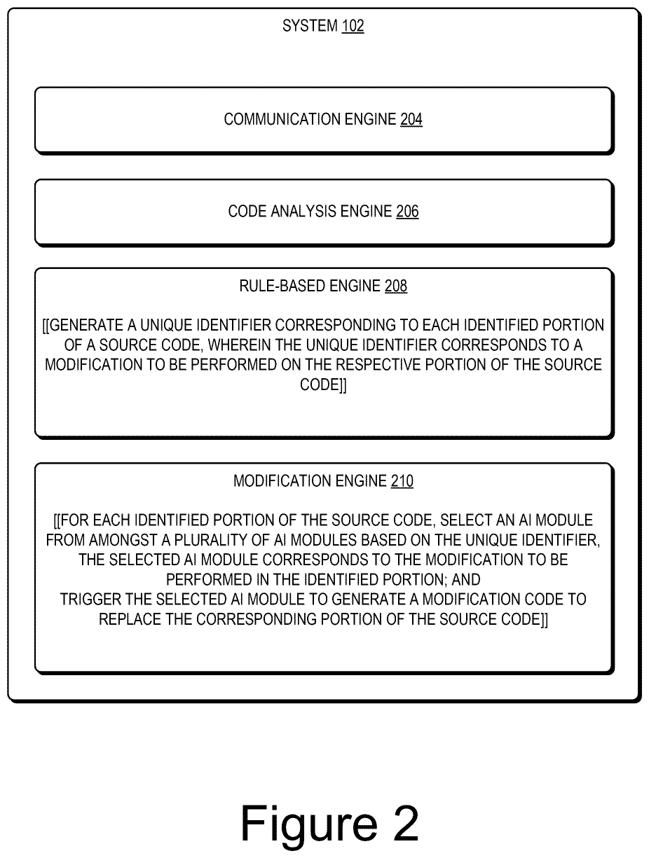

FIG. 2 illustrates the system 102 for code modification, in accordance with an example implementation of the present subject matter.

In an embodiment, the system 102 may include a communication engine 204 configured to query multiple databases, such as databases 106-1, 106-2, . . . 106-N. As explained previously, the databases 106-1, 106-2, . . . 106-N may be maintained by global security organizations and contain reports of vulnerabilities discovered in publicly released software packages. The communication engine 204 accesses these vulnerability reports to identify potential security issues in the source code. In an example, the communication engine 204 may employ web bots to monitor the databases 106-1, 106-2, . . . 106-N for new vulnerability releases, automatically triggering internal processes when relevant vulnerabilities are detected. This may enable the system 102 to stay current with the latest security threats and vulnerabilities, ensuring timely responses to potential risks in the codebases of the code pipelines stored in the dataset 104. Alternatively, the communication engine 204 may interface with proprietary sources managed by organizations, or internal vulnerability tracking systems to identify the vulnerabilities in the codebases of the code pipelines stored in the dataset 104.

Further, in an embodiment, the system 102 may include a code analysis engine 206 that may implement the one or more code analysis tools to scan all the code pipelines stored in the dataset 104. The scanning process is to identify which code pipelines contain software packages that have vulnerabilities, as reported in the databases 106-1, 106-2, . . . 106-N and obtained by the system 102. When a code pipeline is found to contain vulnerable software packages, the code analysis tools may perform a more detailed scan. This scan focuses on locating a specific portion of a source code within the affected codebase that may be vulnerable. Upon identifying one or more vulnerable portions of the source code, the code analysis tools analyze the vulnerable portions of the source code to determine what modifications are necessary to eliminate the vulnerability. For each identified vulnerable portion of the source code, the code analysis tools may specify a modification that may be implemented to address the corresponding vulnerability.

Similarly, as explained previously, the code analysis engine 206 may implement the one or more code analysis tools to identify the portions of the source code that may need modification to enhance quality of the source code. In an example, the code analysis tools may scan the codebase to detect areas where efficiency, readability, or usability may be enhanced. The code analysis tools may flag portions of one or more source codes of the codebase that are overly complex, poorly structured, or inefficiently implemented. The code analysis tools may also identify areas of the source codes where documentation is insufficient or where naming conventions may be improved for better clarity. For each identified portion that may benefit from quality enhancement, the code analysis tools may suggest specific modifications or refactoring that may be done to enhance the quality.

The system 102 further includes a rule-based engine 208. The rule-based engine 208 may be configured to process the output from the code analysis engine 206 and generate unique identifiers for each identified portion of the source code that requires modification. Each unique identifier generated by the rule-based engine 208 may correspond to a specific type of modification to be performed on the respective portion of the source code.

In an embodiment, the system 102 may also include a modification engine 210. The modification engine 210 may include a plurality of AI modules that may be configured to generate modification codes to replace the identified portions of the source code to remove either the vulnerability or enhance the quality of the source code. In an embodiment, each of the plurality of AI modules may be a generative AI module capable of producing the modification codes based on the identified vulnerability and the context of the existing source code.

In an example, the unique identifier generated by the rule-based engine 208 may allow the modification engine 210 to select an appropriate AI module from amongst the plurality of available AI modules. Each AI module selected by the modification engine 210 may be configured to generate a code modification that may address the specific vulnerability issue or quality issue identified in the source code. The selected AI module may analyze the context of the vulnerable portion of the source code, and generate a modification code to replace or update the vulnerable portion of the source code. This generated modification may eliminate the identified vulnerability or enhance the quality of the source code while maintaining the intended functionality of the source code. Once generated, the modification engine 210 may apply this modification code to the affected portion of the source code, effectively updating the codebase to resolve the identified vulnerability or enhance the quality of the source code.

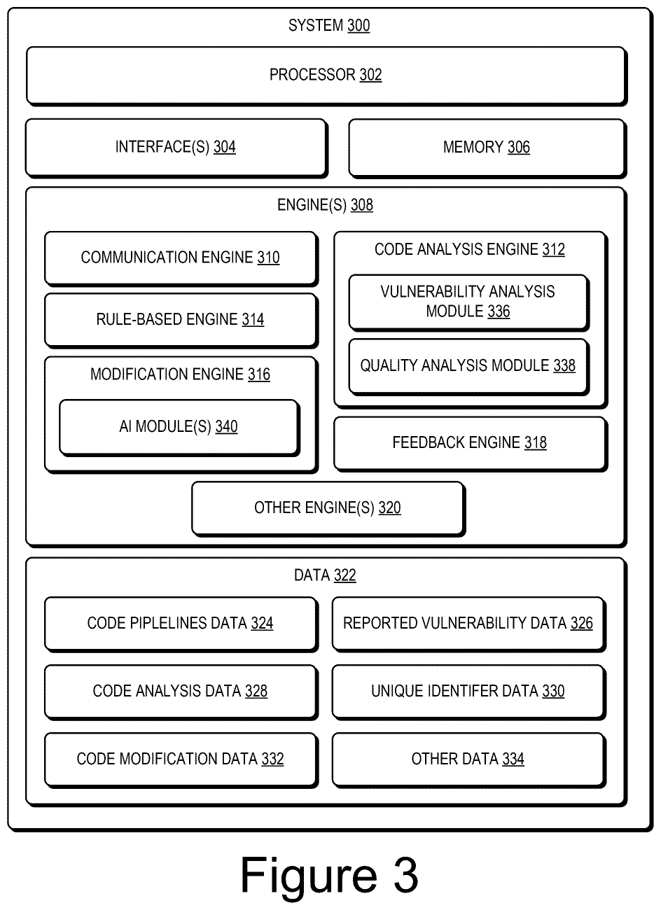

The present subject matter thus provides a solution for code modification that may adapt to various types of code vulnerabilities and quality issues generating appropriate fixes to address the identified vulnerabilities and the quality issues with minimal human intervention. This enables efficient and timely responses to identified security issues and quality improvements in the code pipelines, enhancing overall code quality, reducing the risk of exploitation, and improving code maintainability and efficiency. To elaborate on the functionality of the system 102 for code modification, reference is made to FIG. 3.

FIG. 3 illustrates a system 300 for code modification that identifies portions of a source code that need revision or modification, in accordance with an example implementation of the present subject matter. In an example, the modification may be required due to vulnerabilities or other reasons, for example, to enhance the quality of the source code. The system generates appropriate modifications to be made in the source code to address the identified vulnerabilities or enhance the quality of the source code with minimal human intervention.

In an example, the system 300 is similar to the system 102, as explained in reference to FIGS. 1 and 2. In an example, the system 300 depicted in FIG. 3 may be any computing device. Examples of the system 300 may include but are not limited to servers, desktop computers, laptops, smartphones, personal digital assistants (PDAs), and tablets.

The system 300 comprises a processor 302. In an example, the processor 302 may be implemented as microprocessors, microcomputers, microcontrollers, digital signal processors, central processing units, state machines, logic circuitries, and/or other devices that manipulate signals based on operational instructions.

The system 300 may further comprise an interface(s) 304. The interface(s) 304 may include a variety of software and hardware interfaces that allow interaction of the system 300 with other communication and computing devices, such as network entities, web servers, external repositories, and peripheral devices, such as input/output (I/O) devices. For example, the interface(s) 304 may couple the system 300 with the one or more databases 106-1, 106-2, . . . 106-N that host the data corresponding to the reported vulnerabilities as discussed herein. In another example, the interface(s) 304 may couple the system 300 with a user device, such as the user device 110 through which the developers may interact with the system 300. The interface(s) 304 may also enable the coupling of internal components, of the system 300 with each other, such as the aforementioned dataset 104.

Further, the system 300 comprises a memory 306. The memory 306 may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes.

The system 300 further includes engine(s) 308 and data 322. The engine(s) 308 may be implemented as a combination of hardware and programming, for example, programmable instructions to implement a variety of functionalities of the engine(s) 308. In examples described herein, such combinations of hardware and programming may be implemented in several different ways. For example, the programming for the engine(s) 308 may be executable instructions. Such instructions in turn may be stored on a non-transitory machine-readable storage medium which may be coupled either directly with the system 300 or indirectly (for example, through networked means).

In an example, the engine(s) 308 may include a processing resource, for example, either a single processor or a combination of multiple processors, to execute such instructions. In the present examples, the processor-readable storage medium may store instructions that, when executed by the processing resource, implement the engine(s) 308. In other examples, the engine(s) 308 may be implemented as electronic circuitry.

The engine(s) 308 include a communication engine 310, a code analysis engine 312, a rule-based engine 314, a modification engine 316, a feedback engine 318, and other engine(s) 320. In an example, the communication engine 310, the code analysis engine 312, the rule-based engine 314, and the modification engine 316 are similar to the communication engine 204, the code analysis engine 206, the rule-based engine 208, and the modification engine 210, respectively, as explained in reference to FIG. 2. The other engine(s) 320 may further implement functionalities that supplement applications or functions performed by the system 300 or any of the engine(s) 308 of the system 300. The data 322, on the other hand, includes data that is either stored or generated as a result of functionalities implemented by the system 300 or any of the engine(s) 308. It may be further noted that information stored and available in the data 322 may be utilized by the engine(s) 308 for executing the process of modification of a source code by generating a modification code to replace a corresponding portion of the source code that is identified to have an issue, for example, a vulnerability issue or a quality issue. Herein, the vulnerability issue may also be referred to as a security issue.

In an example, the data 322 may comprise code pipelines data 324, reported vulnerability data 326, code analysis data 328, unique identifier data 330, code modification data 332, and other data 334. The data 322 serves, amongst other things, as a repository for storing data that may be fetched, processed, received, or generated by one or more of the engine(s) 308.

In an example implementation of the present subject matter, an organization working on developing a software application may maintain a dataset, such as the dataset 104, that stores data corresponding to each of a plurality of code pipelines used in the development of the software application. In an example, a code pipeline may be understood as a series of automated processes that allow developers to compile, build, test, and deploy their code while developing the software application. The code pipeline generally includes stages, such as source control management, build automation, test automation, and deployment automation.

In an example, the data corresponding to the code pipelines may include, but is not limited to, details related to all programming languages used in the development of different codebases of the software application, tech-stack artifacts, packages used in the code pipelines, other artifacts related to lines of code present in a file, and information on how many files are present in each project of the codebases. The data corresponding to the code pipelines may be collected during the development process of the software application and may be stored in the dataset 104 as the code pipelines data 324.

As explained previously, the one or more databases 106-1, 106-2, . . . 106-N may store details pertaining to the reported vulnerabilities in the publicly released software packages as and when a vulnerability is found or reported. In cases where the codebases of the code pipelines used in the development of the software application use software packages in which vulnerabilities have been reported, it is possible that the reported vulnerabilities may also affect the codebases of the software application.

Thus, to automatically trigger the identification of a pipeline that may be affected due to the reported vulnerabilities, various mechanisms such as crawlers, web bots, and RSS feed may be deployed to monitor the releases of the vulnerabilities related to the software packages that are used in the code pipelines during the development of the software application. In an example, the web bots may interact with the communication engine 310 and notify the communication engine 310 as and when the vulnerabilities are reported that correspond to the software packages that have been used in the development of the software application. For example, if a source code of a codebase of the software application is written in a programming language that uses a specific library or framework, and a vulnerability is reported for that library or framework, the web bots may flag this vulnerability to the communication engine 310 as potentially affecting the codebase. In another example, the address of web locations of the one or more databases 106-1, 106-2, . . . 106-N may be preconfigured in the communication engine 310 from where the communication engine 310 may access the reported vulnerabilities report.

In an example, whenever the web bots notify regarding the reported vulnerability, the communication engine 310 may interact with the web bots and the one or more databases 106-1, 106-2, . . . 106-N to parse data corresponding to the vulnerability. The data corresponding to the reported vulnerability parsed by the communication engine 310 may include, but is not limited to, vulnerability score given to the reported vulnerability in the one or more databases 106-1, 106-2, . . . 106-N. The data corresponding to the reported vulnerability parsed by the communication engine 310 may be stored in the data 322 of the system 300 as the reported vulnerability data 326. In one example implementation, the system 300 may be configured to initiate a process to analyze the codebase to determine if it is indeed impacted by the reported vulnerability.

In an example, to determine if any of the codebases of the code pipeline is indeed impacted by a reported vulnerability, a search operation may be performed to obtain the affected code pipeline and the details related to the vulnerability in the affected pipeline, including the location of a source code that has the vulnerability issue. To achieve this, the code analysis engine 312 may include a vulnerability analysis module 336 that may deploy one or more code analysis tools to analyze codebases of the code pipeline to identify a codebase that may have one or more source codes affected by the reported vulnerability.

In an embodiment, the code analysis tools may be integrated as a functionality of the system 300 itself. In an alternative embodiment, the code analysis tools may be independent of the system 300 and may be accessed by the vulnerability analysis module 336 via an application program interface (API). In this configuration, the code analysis tools may exist as separate software applications or services running on different servers or cloud platforms. The vulnerability analysis module 336 may communicate with these external code analysis tools through standardized API calls, sending requests for analysis and receiving results.

In an embodiment, the code analysis tools may be understood as a stack of multiple individual code analysis tools, with each configured to identify specific types of vulnerabilities and quality issues in the source code. The code analysis tools may work in parallel or sequentially to identify vulnerabilities or quality issues in the source code. In an example, example of the code analysis tools may include, but are not limited to SonarQube, Coverity, Checkmarx, Burp Suite, OWASP ZAP, Black Duck, Twistlock, and WhiteSource.

In an example, the code analysis tools may be interfaced with the one or more databases 106-1, 106-2, . . . 106-N, for example, through the API, to access the reported vulnerability data and compare the same with the codebases of the code pipelines stored in the dataset 104.

In an example, based on the analysis of the reported vulnerabilities and the codebases of the code pipeline of the software application received from the code analysis tools, the vulnerability analysis module 336 may identify a codebase that contains a source code that may be affected by a reported vulnerability. The vulnerability analysis module 336 may further use the code analysis tools to analyze the source code to identify a location of the vulnerability issue in the source code. In an example, in identifying the location of the vulnerability issue in the source code, the vulnerability analysis module 336 may identify one or more portions of the source code that may have the reported vulnerability. In an example, the vulnerabilities issues may include, but are not limited to, buffer overflows, SQL injection flaws, cross-site scripting (XSS) vulnerabilities, authentication bypass issues, insecure cryptographic storage, insufficient input validation, race conditions, memory leaks, unhandled exceptions, hardcoded credentials, improper error handling, use of outdated libraries or components, insecure network communication protocols, privilege escalation vulnerabilities, remote code execution flaws, denial of service vulnerabilities, and security misconfigurations in deployment settings.

In an example, in addition to the identification of the location of the vulnerability issue in the source code, the vulnerability analysis module 336 may also determine other additional details corresponding to the affected code pipeline. In an example, the additional details may include, but are not limited to, a type of the vulnerability, programming language of the portions of the source code that are affected by the vulnerability, location of the source code in the codebase, and vulnerability score for a vulnerability affecting each portion of the source code based on the vulnerability score of the reported vulnerability.

In an example, once the portions of the source code that are affected by the reported vulnerability are identified, the vulnerability analysis module 336 may cause the code analysis tools to identify, for each identified portion, a modification to be performed to address the reported vulnerability. For example, if a buffer overflow vulnerability is detected in a C++ function of the source code that handles user input, the code analysis tools may identify that the modification required is to replace the vulnerable function with a safer alternative that may include proper bounds checking. The code analysis tools may suggest replacing a function like strcpy( ) with strncpy( ) and adding appropriate buffer size checks to prevent potential overflow conditions.

In an example embodiment, the code analysis engine 312 may further include a quality analysis module 338 that may deploy the code analysis tools to analyze the source code to identify one or more portions of the source code that, although may not have any vulnerability issue, may require modification to improve quality of the source code. The quality of the source code may be required to be improved in cases including, but not limited to, where the source code exhibits poor efficiency, readability, and/or usability. For example, the quality analysis module 338 may identify portions of the source code with excessive nesting, long methods, or unused variables, and suggest refactoring as a modification to enhance the readability and efficiency of the source code. In an example, the data collected by the vulnerability analysis module 336 and the modification identified by the code analysis tools to overcome the vulnerability in the source code or to improve the quality of the source code may be stored in the memory 306 of the system 300 as the code analysis data 328.

In an embodiment, the rule-based engine 314 of the system 300 may generate a unique identifier corresponding to each portion of the source code identified to be affected by the reported vulnerability. In an example, the unique identifier may correspond to the modification to be performed on the respective portion of the source code. In an example, generating the unique identifier may involve encoding information about the required modification within the unique identifier itself, or linking the identifier to the code analysis data 328 that contains detailed information about the portions of the source code that are affected by the vulnerability. The unique identifier may include as metadata: the modification to be performed to address the vulnerability in the identified portion of the source code, the type of the vulnerability, the programming language of the portions of the source code that are affected by the vulnerability, the location of the source code in the codebase, and the vulnerability score for a vulnerability affecting each portion of the source code based on the vulnerability score of the reported vulnerability. The unique identifier generated by the rule-based engine 314 corresponding to each identified portion of the source code may be stored in the memory 306 of the system 300 as the unique identifier data 330.

In an example, to generate a modification code that may replace each portion of the source code that is identified, the modification engine 316 may be used. For the purpose, the modification engine 316 may include a plurality of artificial intelligence (AI) modules 340. For each identified portion of the source code, the modification engine 316 may select an AI module from amongst the plurality of AI modules 340 that corresponds to the modification to be performed in the identified portion of the source code. In an example, the AI module may be selected based on the unique identifier assigned to each portion of the source code identified to be affected by the vulnerability. As explained previously, the unique identifier may include the metadata pertaining to the type of enhancement or vulnerability, the programming language, and the required modification, which may guide the selection of the appropriate AI module. Further, once the AI module is selected, the modification engine 316 may trigger the selected AI module to generate a modification code to replace the corresponding portion of the source code.

In an example, the AI modules 340 may employ Large Language Models (LLMs) that may include, but are not limited to, OpenAI Codex, DeepCode, and GitHub Copilot for generating the modification code. In an example, these LLMs may utilize advanced natural language processing and code pattern recognition techniques to generate appropriate code modifications that may replace the identified portion of the source code based on the unique identifier. In an example, the AI modules 340 may be trained on extensive repositories of code, best practices, and known vulnerability fixes, ensuring that the generated code modifications are effective and align with coding standards. The modification code generated by the AI modules 340 may be context-aware, taking into account the specific code environment, vulnerability type, and surrounding code structure to produce tailored and effective solutions.

In an example, the modification code generated by the AI modules 340 may be context-aware modification code. This means that the modification code generated by the AI modules 340 may take into account the surrounding structure of the source code, the specific programming language being used, the overall architecture of the software application, and the nature of the identified vulnerability. By considering these contextual factors, the AI modules 340 may generate the modification code that not only addresses the immediate vulnerability or the quality issue but also integrates seamlessly with the existing codebase, maintains consistent coding styles, and adheres to project-specific conventions.

In an example, in cases where there is more than one portion of the source code that may need to be replaced with the modification code, the rule-based engine 314 may assign a priority to each identified portion of the source code. The rule-based engine 314 may parse each identified portion of the source code in the modification engine 316 for the generation of the modification code in an order corresponding to the priority assigned to each identified portion of the source code. In an example, the priority may be assigned based on the severity score of the vulnerability. As explained previously, the severity score may be determined using the reported vulnerability data. For example, a vulnerability with a high score of 9.0 or above may be given a higher priority than one with a medium score of 5.0 to 6.9. In an example, consider a scenario where the rule-based engine 314 identifies three vulnerable portions of code: A, B, and C, vulnerability A may have a severity score of 8.5 (high), B may have a score of 6.2 (medium), and C may have a score of 4.3 (low). The rule-based engine 314 may assign priorities as follows: A (highest priority), B (medium priority), and C (lowest priority). Consequently, the AI modules 340 may generate modification code for vulnerability A first, followed by B, and then C. This prioritization may ensure that the most critical vulnerabilities are addressed promptly, potentially mitigating significant security risks more quickly.

Though the LLMs of the AI modules 340 may be trained to be context-aware with respect to the source code, there may be scenarios where complex code requires refactoring, or the generated code from the LLMs may not meet the desired code standards and may produce modification code that is not appropriate to replace the vulnerable portion of the source code. For such scenarios, the system 300 may include a feedback engine 318. In an example, the feedback engine 318 may take control, and the LLMs may be fine-tuned and better prompt-engineered to obtain higher quality code. Once the desired code is obtained from the LLMs, a review of the generated modification code may be performed, for example, by a developer. The approved modification code then replaces the old vulnerable code in files of the codebase, and the new code files may be readied for further steps of testing and deployment.

Therefore, the present subject matter provides a solution for code modification that adapts to various types of code issues, including vulnerabilities and quality issues. The present subject matter provides for generation of appropriate code modifications to address these identified issues within the source code with minimal human intervention. This enables efficient and timely responses to security vulnerabilities and quality deficiencies in the code pipelines. Furthermore, the present subject matter integrates multiple workflows, such as vulnerability detection, code quality assessment, and automated modification generation, into a unified process. This integration streamlines the entire code maintenance and improvement lifecycle, allowing for seamless handling of different types of code enhancements within a single framework. As a result, the present subject matter enhances the overall code quality, mitigates exploitation risks, improves code maintainability and efficiency, and optimizes the entire code management process.

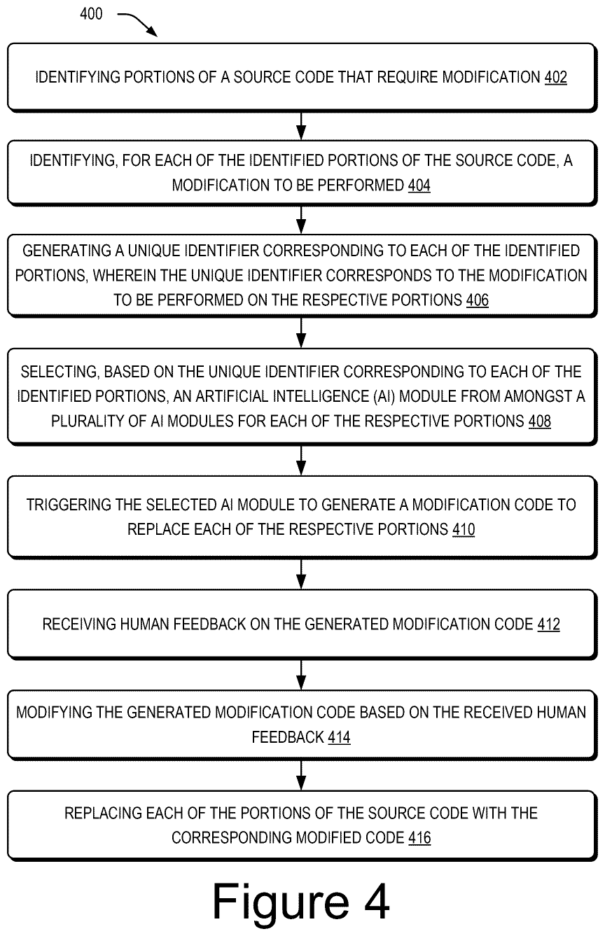

FIG. 4 illustrates a flowchart of method 400 for code modification that provides for automated detection, analysis, and remediation of various issues, such as security issues or quality issues through integrated workflows, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer-readable medium. The non-transitory computer-readable medium may include, for example, digital memories, magnetic storage media, such as magnetic disks and magnetic tapes, hard drives, or optically readable digital data storage media. In an example, the method 400 may be performed by the system 102.

Referring to FIG. 4, at block 402, portions of a source code that require modification are identified. As explained previously, a code pipeline of a software application may include a plurality of codebases. Each of the plurality of codebases may further include a plurality of source codes. In some cases, a source code of the plurality of source codes may develop a vulnerability raising security issues. In other cases, the source code may be written in such a way that the source code does not meet a predefined quality requirement. In an example, the predefined quality requirement may be established at the outset of a project to ensure consistent code quality across the codebase. The predefined quality requirement may include, but are not limited to, adherence to coding standards, performance benchmarks, documentation requirements, and other quality metrics specific to the project. For example, the predefined quality requirements may specify maximum allowable code complexity (e.g., cyclomatic complexity score not exceeding 10 for any function), minimum test coverage (e.g., 80% for new code), adherence to design patterns (e.g., using dependency injection), utilization of standard library functions over custom implementations, consistent code formatting, proper exception handling and logging, or comprehensive API documentation.

The code analysis engine 312 may identify the portions of the source code that may be required to be modified to either address the security issue or improve the quality of the source code, as the case may be. Accordingly, the portions of the source code that require modification are identified, for example, by the code analysis engine 312.

At block 404, for each of the identified portions of the source code, a modification to be performed is identified, for example, by the code analysis engine 312.

At block 406, a unique identifier corresponding to each of the identified portions of the source code is generated, for example, by the rule-based engine 314. In an example, the unique identifier may correspond to the modification to be performed on the respective portion of the source code.

At block 408, based on the unique identifier corresponding to each of the identified portions, an AI module from amongst the plurality of AI modules 340 may be selected for each of the respective portions. In an example, the selection of the AI module 340 may be performed, for example, by the modification engine 316. Each AI module in the plurality of AI modules 340 may be configured for generating specific types of code modifications or improvements. The unique identifier helps determine which AI module is most suitable for generating the required modification for each identified portion of the source code. For example, if the unique identifier indicates a code smell issue, a particular AI module that uses an LLM trained to generate code modifications for correcting code smells may be selected. On the other hand, if the unique identifier indicates a performance optimization issue, a different AI module employing an LLM trained for optimizing code performance may be chosen. In an example, the LLMs of the AI modules 340 may be configured to learn from each modification code approved for replacing the portion of the source code identified to contain the vulnerability issues and the quality issues, thereby allowing the AI modules 340 to improve their performance over time.

At block 410, the selected AI module may be triggered, for example, by the modification engine 316, to generate a modification code to replace each of the respective portions of the source code. The modification code represents the changes or improvements to be made to the identified portion of the source code. These modifications may include, but are not limited to, fixing security vulnerabilities, improving code quality, optimizing performance, or updating deprecated functions. In an example, the AI modules 340 may utilize their specialized algorithms and training data to generate appropriate code modifications tailored to the specific issue identified by the unique identifier.

At block 412, human feedback may be received, for example, at the feedback engine 318, on the generated modification code via a user device, such as the user device 110. This feedback process allows human reviewers, such as the developers, to assess, review and validate the AI-generated code modifications before they are implemented. The feedback may include, but is not limited to, approval, rejection, or suggestions for further refinement of the generated modification code. The human reviewers may provide input on aspects, such as code correctness, adherence to coding standards, potential side effects, or alignment with project-specific requirements. This human-in-the-loop approach may ensure that while the system 300 automates much of the code modification process, it still benefits from human expertise and insight.

At block 414, the modification code generated by the AI modules 340 may be corrected or modified based on the received human feedback. This process may be performed, for example, by the corresponding AI module 340. Depending on the nature of the feedback, the modification engine 316 may take different actions. For example, the modification engine 316 may proceed with implementing the modifications if approved by the human reviewer, use the AI modules 340 to further refine the modification code based on the human feedback, flag the modifications for more extensive human intervention if significant issues are identified, or allow a human reviewer to directly make modifications to the AI-generated modification code.

At block 416, each of the identified portions of the source code may be replaced with the corresponding modification code generated by the AI modules 340 if approved by the human reviewer. This replacement process may be executed automatically by the modification engine 316, ensuring that the approved changes are accurately implemented in the original source code.

Consequently, the example method 400 facilitates automatic code maintenance and healing by identifying vulnerabilities, generating appropriate modifications, and implementing approved changes in the source code. This process helps prevent the introduction of errors, security vulnerabilities, or inefficiencies that may potentially damage the software application or cause issues for its users. In doing so, the present subject matter effectively addresses code quality and security concerns at the interface where software development processes intersect with automated code analysis and modification.

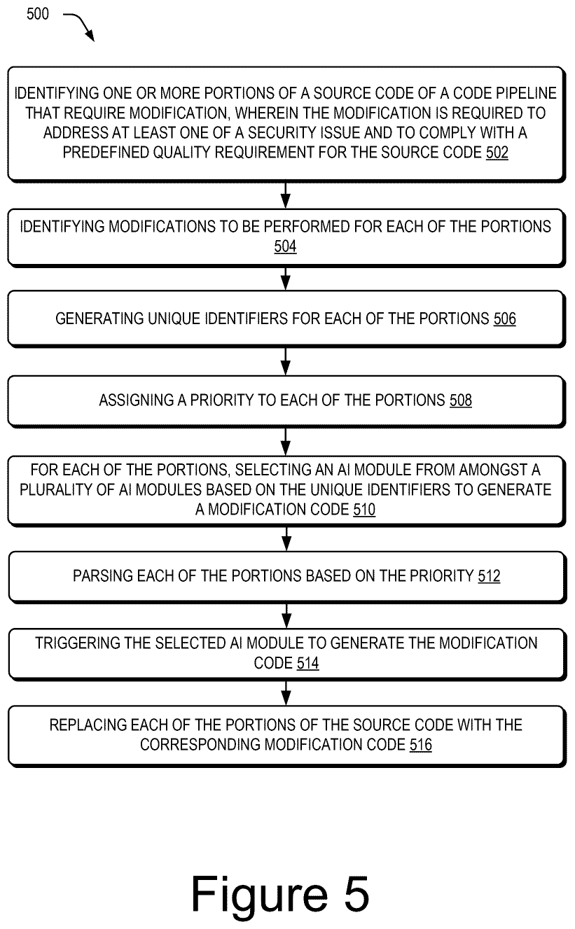

FIG. 5 illustrates a flowchart of a method 500 for code modification, according to another example implementation of the present subject matter. The order in which the above-mentioned method 500 is described is not intended to be construed as a limitation, and some of the described process blocks may be combined in a different order to implement the process, or an alternative process.

Furthermore, the above-mentioned method 500 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 500 may be implemented by the system 102, 300 of FIGS. 1-3.

Referring to FIG. 5, in an embodiment, at block 502, one or more portions of a source code of a code pipeline that require modification may be identified. As explained previously, modifications in the source code may be required either to address security issues or comply with predefined quality requirements. Addressing security issues may include, but is not limited to, identifying vulnerable code patterns, insecure API usage, potential injection points, or other security weaknesses in the source code that may be exploited by malicious actors. On the other hand, addressing the predefined quality requirements may include, but are not limited to, identifying portions of the source code that violate coding standards, exhibit poor performance characteristics, lack proper documentation, or fail to meet other quality metrics established for the project. The quality requirements may encompass factors such as code complexity, maintainability, test coverage, and adherence to design patterns. In some cases, a single portion of a source code may require modification to address both security and quality concerns simultaneously.

In an example, to identify the source code within the code pipeline that requires modification, reference may made to the reported vulnerability reports, and/or quality assessments of code pipelines associated with a software application, for example, by the code analysis engine 312 using various code analysis tools. As explained previously, the vulnerability reports may be obtained by scanning the one or more databases 106-1, 106-2, . . . 106-N.

The quality assessments of the code pipelines may also be performed using the code analysis tools, which may include, but are not limited to, static code analyzers, linters, or other specialized software quality evaluation tools. The code analysis tools may assess various aspects of code quality, such as maintainability, reliability, and efficiency. Based on the results of this analysis or assessment, a code pipeline that may be affected by a reported vulnerability or that fails to meet predefined quality standards may be accessed. In an example, the affected code pipeline may be accessed from a dataset, such as the dataset 104, which serves as a repository for source codes, build configurations, and deployment scripts.

Within the accessed code pipeline, the specific portions of source code requiring modifications are identified by the code analysis tools deployed by the code analysis engine 312. These code analysis tools scan the source code to locate specific portions, functions, classes, or modules that need modification.

In an embodiment, at block 504, modifications to be performed for each portion of the source code may be identified, for example, by the code analysis tools 310.

In an embodiment, at block 506, unique identifiers for each identified portion of the source code requiring modification may be generated, for example, by the rule-based engine 314. As explained previously, the unique identifiers serve as distinct tags that uniquely reference each portion of the source code that requires modification, incorporating contextual information such as file name, line numbers, and issue type.

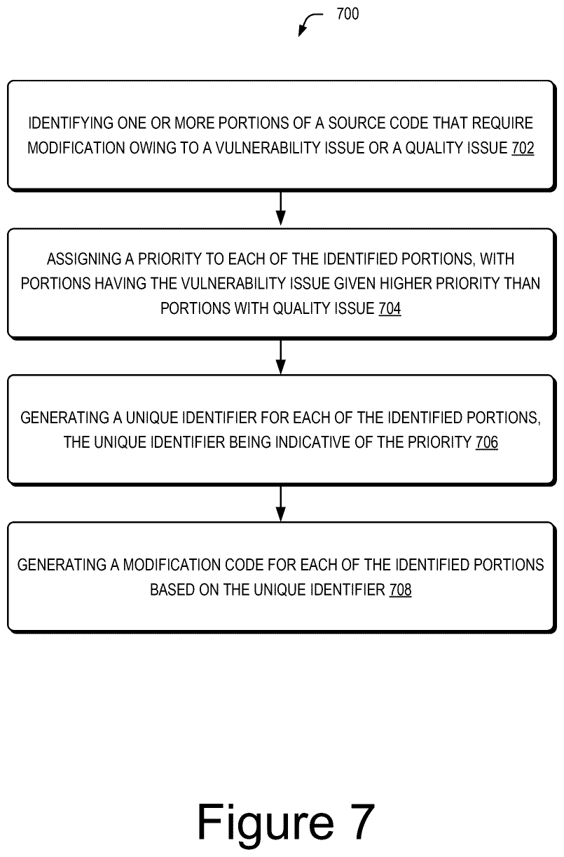

In an embodiment, at block 508, a priority may be assigned to each of the identified portions of the source code requiring modification. As explained previously, the prioritization of the security issues may be based on the severity score of the security issue. This prioritization ensures that critical issues, such as severe security vulnerabilities or bugs in core components, are addressed before less impactful concerns like minor style violations. FIG. 7 further elaborates the process of assigning priority to the identified portions of the source code requiring modification.

In an embodiment, at block 510, the modification engine 316 may select an AI module from amongst the plurality of AI modules 340 based on the unique identifiers to generate a modification code. This selection process involves analyzing the unique identifier to extract relevant information such as issue type, code context, and the severity score. Each AI module 340 may be specialized for specific types of code modifications, such as security patches, performance optimizations, or code style improvements. In an example, the selection process may also employ an ensemble approach, combining multiple AI modules 340 for complex tasks.

At block 512, the identified portions of the source code may be parsed to their corresponding AI modules 340 based on the assigned priority for the generation of the modification code. In an example, each parsed portion may include relevant metadata to be used by the AI modules 340 to generate appropriate code modifications.

At block 514, the selected AI module 340 may be triggered, for example, by the modification engine 316, to generate the modification code.

At block 516, the one or more portions of the source code may be replaced with the corresponding modification code generated by the AI modules 340.

This automated approach of identifying vulnerabilities or quality issues in the source code and generating modifications to address these vulnerabilities and quality issues helps maintain consistency across large codebases, reducing the likelihood of human error in manual code reviews and updates. The reduction in human error also translates to fewer introduced bugs during the maintenance process, leading to more stable and reliable software applications.

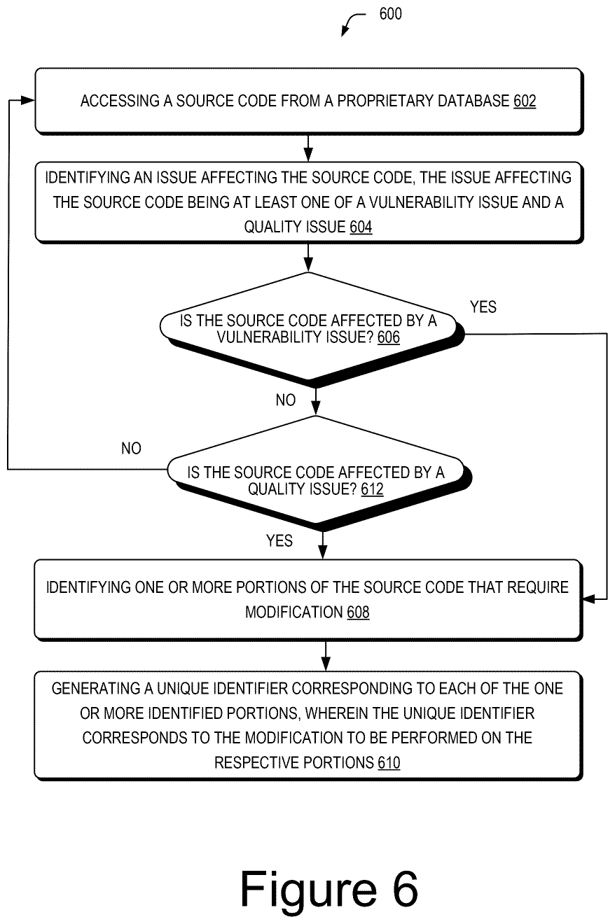

FIG. 6 illustrates a flow diagram of a process 600 for analyzing a source code and generating unique identifiers for portions of the source code identified as having security issues or quality issues, according to an example implementation of the present subject matter. The order in which the above-mentioned process is described is not intended to be construed as a limitation, and some of the described process blocks may be combined in a different order to implement the process or an alternative process.

Furthermore, the above-mentioned process 600 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 600 may be implemented by the system 102, 300 of FIGS. 1-3.

Referring to FIG. 6, at block 602, a source code may be accessed, for example, by the code analysis engine 312, from a proprietary source. In an example, the accessing of the source code may be triggered by publication of the reported vulnerabilities in a code pipeline associated with the source code. These reported vulnerabilities may be published in one or more databases 106-1, 106-2, . . . 106-N, which may include well-known vulnerability databases such as the National Vulnerability Database (NVD), Common Vulnerabilities and Exposures (CVE), or other industry-specific security advisory sources. The proprietary source from which the source code is accessed may be part of the version control system of an organization involved in development of the software applications, such as Git repositories or other code management platforms. The code analysis engine 312 may be configured to regularly monitor the one or more databases 106-1, 106-2, . . . 106-N and automatically initiate the source code access process when new relevant vulnerabilities are reported. In another example, the access of the source code may also be triggered by scheduled code quality assessments, changes in industry security standards, or as part of a continuous integration/continuous deployment (CI/CD) pipeline. This ensures that the source code is promptly analyzed for potential security risks or quality issues as soon as new information becomes available or at regular intervals, facilitating timely remediation and maintaining the overall health of the software application.

At block 604, an issue affecting the source code may be determined, for example, by the code analysis engine 312. As explained previously, the issue affecting the source code may be a vulnerability issue or a quality issue.

At block 606, an assessment is made as to whether the source code is affected by a vulnerability issue. As explained previously, the assessment may be performed by the code analysis engine 312 using the code analysis tools. In case the assessment is affirmative, indicating that a vulnerability issue has been detected, the process 600 proceeds to block 608.

At block 608, one or more portions of the source code that require modification to address the identified vulnerability are identified, for example, by the code analysis engine 312.

At block 610, a unique identifier corresponding to each of the one or more identified portions is generated, for example, by the rule-based engine 314. The unique identifier corresponds to the modification to be performed on the respective portions of the source code. This unique identifier may incorporate information such as the type of issue, severity score if the issue pertains to security issues, and the location of the affected portions within the source code, amongst other information.

However, if at block 606, it is determined that the source code is not affected by a vulnerability issue, the process 600 proceeds to block 612. At block 612, an assessment is made to check whether the source code is affected by a quality issue. In case the assessment is affirmative, the process 600 proceeds to block 608. At block 608, one or more portions of the source code that require modification to address the quality issue are identified, for example, by the code analysis engine 312.

The process 600 then proceeds to block 610, where a unique identifier corresponding to each of the one or more identified portions is generated, for example, by the rule-based engine 314. The unique identifier corresponds to the modification to be performed on the respective portions of the source code to address the quality issue.

However, if at block 612, it is determined that the source code is not affected by the quality issue as well, the process 600 reverts to block 602 where continuous monitoring of the code pipelines of the software application may be performed to access a source code that may be affected by a quality issue or a vulnerability issue.

In some cases, one portion of the source code may include both the vulnerability issue and the quality issue. In such scenarios, the resolution of the vulnerability issue may be prioritized compared to the quality issue.

The assignment of unique identifiers to identified portions of source code requiring modification enables the efficient selection of appropriate AI modules for the generation of the modification codes. In an example, after the modification is performed based on the unique identifier, the modification code may be reanalyzed by the code analysis engine 312. This may help in preventing instances where modification code generated for addressing one issue may inadvertently introduce another error. For example, a portion of the source code modified to address a vulnerability issue may unintentionally introduce a quality issue. By reanalyzing the modification code so generated, such new issues may be identified and addressed, ensuring that the final modification code meets both security and quality requirements.

This reanalysis process may be integrated with the continuous monitoring of code pipelines described in respect of block 602. As modifications are made, the updated modification code may become a part of the ongoing monitoring cycle, allowing for the detection and resolution of any new issues that may arise as a result of the modification code.

FIG. 7 illustrates a flow diagram of a process 700 for analyzing the source code and generating the unique identifiers for portions of the source code identified as having the security issues or the quality issues, according to another example implementation of the present subject matter. The order in which the above-mentioned process is described is not intended to be construed as a limitation, and some of the described process blocks may be combined in a different order to implement the process, or an alternative process.

Furthermore, the above-mentioned process 700 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 600 may be implemented by the system 102, 300 of FIGS. 1-3.

Referring to FIG. 7, at block 702, one or more portions of a source code that require modification owing to a vulnerability issue or a quality issue 702 may be identified, for example, by the code analysis tools. In an example, the quality issue and the vulnerability issue may be understood as two separate issues and the rule-based engine 314 may be capable of identifying if an issue identified in a portion of a source code is a quality issue or vulnerability issue based on reports generated by the quality analysis tools.

At block 704, a priority may be assigned, for example, by the rule-based engine 314, to each of the identified portions of the source code that is affected by either the vulnerability issue or the quality issue, or both. In an example, the priority assigned to each of the identified portions of the source code that is affected by the vulnerability issue may be based on the severity score assigned to each of the identified portions of the source code that is affected by the vulnerability issue. As explained previously, the severity score is a score that may be reported in the vulnerability reports that may be accessed from the one or more databases 106-1, 106-2, . . . 106-N. In another example, the priority that is to be assigned to the quality issue may be based on the predefined quality requirements. The predefined quality requirements for the codebase to which the source code belongs may be accessed from the dataset 104. In an example, the portions having the vulnerability issue may be given a higher priority than portions with the quality issue. For example, consider a portion of a source code is identified with a vulnerability issue having a severity score of 8.5 out of 10, and another portion of the source code has a quality issue related to code complexity exceeding the predefined quality threshold by 20%. The rule-based engine 314 may assign a priority score of 85 to the vulnerability issue (on a 0-100 scale) and a priority score of 60 to the quality issue (based on predefined quality requirement thresholds). In this case, the vulnerability issue may be prioritized for immediate attention due to its higher priority score, while the quality issue may be addressed subsequently.

The vulnerability issues are assigned higher priority due to their potential security risks on the software application. In an example, the priority assignment may be based on factors such as the criticality of the affected code, the potential impact on the security or performance of the software application, and the complexity of the required modification. For example, if more than one vulnerability issue is found in the source code, the one with a higher severity score may be assigned higher priority. This ensures that the most critical vulnerabilities are addressed first, optimizing the overall security improvement of the software application.

At block 706, a unique identifier may be generated for each of the identified portions of the source code, for example, by the rule-based engine 314. In an example, the unique identifier may be indicative of the assigned priority. This unique identifier may include information pertaining to the issue type, priority, location in the code, and other relevant metadata. The unique identifier serves as a key reference point for tracking and managing the issue throughout the remediation process.

At block 708, a modification code for each of the identified portions of the source code may be generated, for example, by the modification engine 316 based on the unique identifier. In doing so, the modification engine 316 may select an AI module from amongst the plurality of AI modules 340 based on the unique identifier for each identified portion. Based on the information encoded in the unique identifier, the modification engine 316 selects the most appropriate AI module 340 for generating the modification code, ensuring that the most suitable AI module 340 is chosen for each particular issue. Once selected, the AI module 340 is activated to generate code modifications that address the identified issue. The AI module 340 may utilize techniques such as machine learning, natural language processing, and code pattern analysis to produce appropriate fixes that align with best practices and coding standards. In an example, the identified portions of the source code may be replaced with the corresponding modification code generated by the AI module 340.

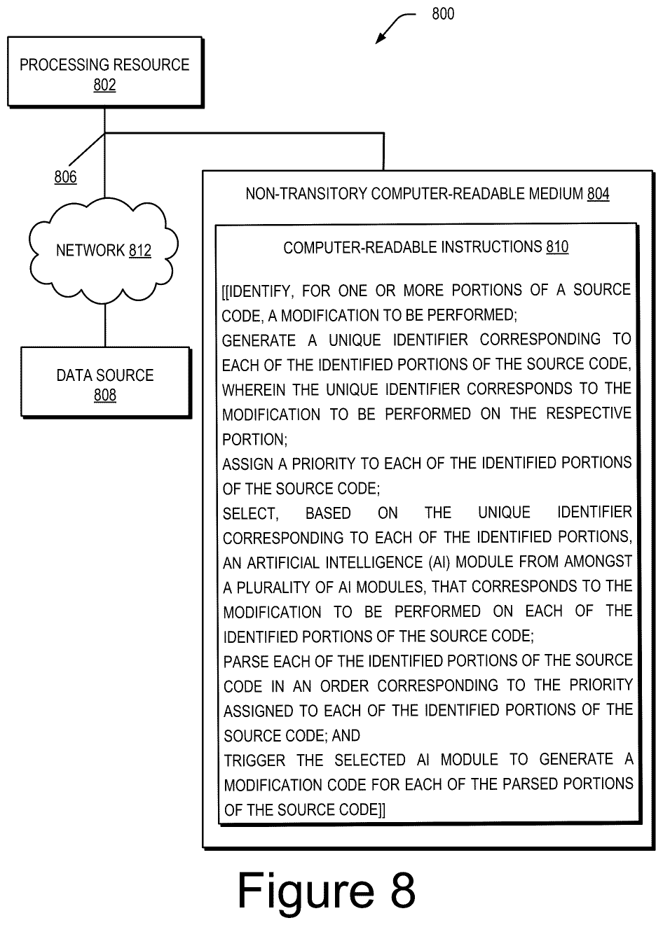

FIG. 8 illustrates a computing environment 800 for code modifications, according to an example implementation of the present subject matter. The computing environment 800 includes a processing resource 802 communicatively coupled to a non-transitory computer-readable medium 804 through a communication link 806. In an example, the processing resource 802 may be the processor of the system 102, 300 for code modification, which fetches and executes computer-readable instructions from the non-transitory computer-readable medium 804.

The non-transitory computer-readable medium 804 may be, for example, an internal memory device or an external memory device. In an example implementation, the communication link 806 may be a direct communication link, such as any memory read/write interface. In another example implementation, the communication link 806 may be an indirect communication link, such as a network interface. In such a case, the processing resource 802 may access the non-transitory computer-readable medium 804 through a network 812. The network 812 may be a single network or a combination of multiple networks and may use a variety of different communication protocols.

The processing resource 802 and the non-transitory computer-readable medium 804 may also be communicatively coupled to data sources 808. The data source(s) 808 may be used to store data corresponding to the product recall management process, for example.

In an example implementation, the non-transitory computer-readable medium 804 comprises executable instructions 810 for enabling the code modifications.

According to an example implementation of the present subject matter, the instructions 810 may cause the processing resource 802 to identify, for one or more portions of a source code of a codebase of a code pipeline, a modification to be performed. The modification may be required either in response to the determination of a vulnerability in the source code or in response to determination of a quality issue in the source code. In an example, the instructions 810 may cause the processing resource 802 to access the vulnerability reports from the one or more databases 106-1, 106-2, . . . , 106-N, and analyze the vulnerability reports to identify the one or more portions of the source code that require modification.

To accomplish this, the instructions 810 may cause the processing resource 802 to deploy various code analysis tools that refer to the vulnerability reports to identify the portions of the source code that require modification to address a security issue. These code analysis tools may include static code analyzers, dynamic analysis tools, and vulnerability scanners that may detect potential security flaws such as buffer overflows, SQL injection vulnerabilities, or cross-site scripting (XSS) issues.

In an example, the source code in which the vulnerability or the quality issue is to be determined and addressed may be accessed from amongst one or more proprietary sources identified in the vulnerability reports. In another example, code analysis tools may analyze each source code file of a codebase to identify portions of a source code that require modification to comply with predefined quality requirements. These quality requirements may include aspects such as code complexity, maintainability, readability, and adherence to coding standards.

In an example, the instructions 810 may cause the processing resource 802 to employ metrics such as cyclomatic complexity, code duplication percentage, or comment-to-code ratio to assess quality of a source code. The instructions 810 may also cause the processing resource 802 to check for proper error handling, memory management, and resource utilization to ensure robust and efficient code.

In an embodiment, the instructions 810 may cause the processing resource 802 to generate a unique identifier corresponding to each of the identified portions of the source code, with each unique identifier corresponding to the modification to be performed on the respective portion. The rule-based engine 314 may generate these unique identifiers based on predefined rules and the nature of the required modification, incorporating information such as issue type, severity score, location of the issue within the source code, and a brief description of the needed change as suggested by the code analysis tools.

In an embodiment, the instructions 810 may further cause the processing resource 802 to assign a priority to each of the identified portions of the source code. In an example, in the case of a vulnerability issue, the priority may be assigned based on the severity score of the vulnerability issue identified in the portions of the source code. Similarly, in case of a quality issue, the priority may be assigned based on the extent to which the code deviates from the predefined quality standards. The rule-based engine 314 may determine the priorities, considering factors such as the potential impact of the issue, the likelihood of exploitation, and the criticality of the affected code portion to the overall functionality of the software application. For security vulnerabilities, the rule-based engine 314 may leverage the severity score provided in the vulnerability reports. Quality issues may be prioritized based on their potential impact on the performance of the software application, maintainability, or user experience. The priority levels may be categorized as critical, high, medium, or low, with corresponding numerical values for more granular sorting. This prioritization of the issue enables the system 300 to address the most critical issues first, optimizing resource allocation and minimizing potential risks to the software application.

In an embodiment, the instructions 810 may cause the processing resource 802 to select an AI module from amongst the plurality of AI modules 340, based on the unique identifier corresponding to each of the identified portions of the source code. In an example, this selection of the AI module 340 may be managed by the modification engine 316 that utilizes the information encoded in the unique identifier to determine the most appropriate AI module 340 for each specific modification. In an example, the AI modules 340 may comprise a plurality of LLMs, each trained to handle specific types of code modifications, such as addressing particular security vulnerabilities, improving code quality aspects, or working with specific programming languages or frameworks. In an example, the factors to be considered in the selection of the AI module 340 may include, but are not limited to, process considers various factors type of the issue, the nature of the required modification, the programming language or framework of the source code, and the complexity of the modification.

In an embodiment, the instructions 810 may cause the processing resource 802 to parse to the modification engine 316 each of the identified portions of the source code in an order corresponding to the priority assigned to each of the identified portions of the source code. In an example, the parsing may involve sorting the identified portions based on their assigned priorities, extracting relevant code snippets with surrounding context, preparing the parsed code in a format compatible with the selected AI modules 340, and attaching metadata including the unique identifier and priority level. In an example, the modification engine 316 may implement a queue system to manage the parsed code portions, ensuring higher-priority items are processed first while allowing for dynamic updates if new, higher-priority issues are identified. This optimizes the overall efficiency and impact of the code maintenance process by addressing the most critical issues first.

In an embodiment, the instructions 810 may cause the processing resource 802 to trigger the selected AI module 340 to generate a modification code for each of the parsed portions of the source code. In an example, the process may involve the AI module 340 receiving the parsed code portion along with its associated metadata, analyzing the code while considering the specific issue, surrounding context, and relevant coding standards, and then generating an appropriate modification code. In an example, the AI module 340 may generate multiple modification options if applicable, rank them based on effectiveness and adherence to standards, and perform preliminary validation. The generated modification code, which may include explanatory comments, is then passed back to the modification engine 316 for further processing.

In an embodiment, once the modification code is generated by the AI modules 340, the instructions 810 may cause the processing resource 802 to receive human feedback on the generated modification code and modify the generated modification code based on the received human feedback. In an example, receiving the human feedback may involve presenting the AI-generated modification code to human reviewers, such as the developers through a user interface of the user device 110, allowing them to review, annotate, approve, reject, or request changes. The human reviewers may provide specific line-by-line feedback or general comments, which the modification engine 316 may relay back to the AI modules 340 for revision if necessary. In an example, this iterative process may continue until the human reviewers are satisfied with the proposed modifications. In another example, the human reviewers may themselves make the necessary changes in the modification code generated by the AI modules 340. In an example, the system 300 may track and store the feedback provided by the human reviewers, using it to improve performance of the AI modules 340 over time through continuous learning. In an example, the once approved, the final modified code may be integrated into the codebase.

Thus, the methods, systems, and non-transitory computer-readable media of the present subject matter address the need for efficient automatic code maintenance and healing. By enabling the modification engine to initiate code modifications independently and communicate critical attribute information to the rule-based engine, the invention facilitates a more responsive and comprehensive approach to code quality and security. This integrated process allows for immediate action on identified vulnerabilities or issues while simultaneously triggering assessments for potentially affected code segments. Further, the ability to concurrently execute code analysis and modification by analyzing and comparing code attributes across multiple repositories may expedite the code maintenance process, while also providing more efficient healing by allowing for simultaneous investigation of other code segments based on the attributes that caused the issue in the code determined to be modified by the modification engine.

While specific implementations of the automatic code maintenance and healing system have been discussed, it is to be understood that the appended claims are not necessarily limited to the specific features or methods described. Rather, the specific features and methods are disclosed as example implementations for enhancing the efficiency and effectiveness of code maintenance processes across various software development environments.

1. A system for code modification comprising:
a communication engine to query one or more databases to access vulnerability reports indicative of a source code that requires modification;
a code analysis engine to:
analyze the source code to identify one or more portions of the source code that require modification; and
identify, for each identified portion, a modification to be performed;
a rule-based engine to generate a unique identifier corresponding to each identified portion of the source code, wherein the unique identifier corresponds to the modification to be performed on the respective portion; and
a modification engine comprising a plurality of artificial intelligence (AI) modules, wherein, for each identified portion of the source code, the modification engine is to:
select, based on the unique identifier, an AI module from amongst the plurality of AI module, that corresponds to the modification to be performed in the identified portion of the source code; and
trigger the selected AI module to generate a modification code to replace the corresponding portion of the source code.

2. The system of claim 1, wherein the rule-based engine is further configured to assign a priority to each identified portion of the source code,
wherein the modification engine is to:
parse each identified portion of the source code for generation of the modification code in an order corresponding to the priority assigned to each identified portion of the source code.

3. The system of claim 1, further comprising a feedback engine configured to:
receive human feedback on the generated modification code; and
modify the generated modification code based on the received feedback.

4. The system of claim 1, wherein the communication engine is to access the source code from amongst one or more proprietary sources identified in the vulnerability reports.

5. The system of claim 1, wherein the communication engine is to access the vulnerability reports from web locations, the address of the web locations being preconfigured in the communication engine.

6. The system of claim 1, wherein the code analysis engine comprises at least one code vulnerability analysis module configured to analyze the source code to identify one or more portions of the source code that require modification to be performed for addressing a security issue.

7. The system of claim 1, wherein the code analysis engine comprises a code quality analysis module configured to analyze the source code to identify one or more portions of the source code that require modification to comply with a predefined quality requirement for the source code.

8. A method for code modification comprising:
identifying portions of a source code that require modification;
identifying, for each of the identified portions of the source code, a modification to be performed;
generating a unique identifier corresponding to each of the identified portions, wherein the unique identifier corresponds to the modification to be performed on the respective portions;
selecting, based on the unique identifier corresponding to each of the identified portions, an artificial intelligence (AI) module from amongst a plurality of AI modules for each of the respective portions;
triggering the selected AI module to generate a modification code to replace each of the respective portions;
receiving human feedback on the generated modification code;
modifying the generated modification code based on the received human feedback; and
replacing each of the portions of the source code with the corresponding modified code.

9. The method of claim 8, further comprising:
assigning a priority to each of the identified portions of the source code; and
parsing each identified portion of the source code for generation of the modification code in an order corresponding to the priority assigned to each identified portion of the source code.

10. The method of claim 8, further comprising:
accessing vulnerability reports from one or more databases; and
analyzing the vulnerability reports to identify the portions of the source code that require modification.

11. The method of claim 10, further comprising:
accessing the source code from amongst one or more proprietary sources based on the vulnerability reports.

12. The method of claim 10, further comprising:
accessing the vulnerability reports from one or more web locations, wherein an address of each of the one or more web locations is preconfigured.

13. The method of claim 8, wherein identifying portions of the source code that require modification comprises analyzing the source code to identify portions that require modification to address a security issue.

14. The method of claim 8, wherein identifying the portions of the source code that require modification comprises analyzing the source code to identify portions that require modification to comply with a predefined quality requirement for the source code.

15. A non-transitory computer-readable medium comprising instructions that, when executed by one or more processors, cause the one or more processors to:
identify, for one or more portions of a source code, a modification to be performed;
generate a unique identifier corresponding to each of the identified portions of the source code, wherein the unique identifier corresponds to the modification to be performed on the respective portion;
assign a priority to each of the identified portions of the source code;
select, based on the unique identifier corresponding to each of the identified portions, an artificial intelligence (AI) module from amongst a plurality of AI modules, that corresponds to the modification to be performed on each of the identified portions of the source code;
parse each of the identified portions of the source code in an order corresponding to the priority assigned to each of the identified portions of the source code; and
trigger the selected AI module to generate a modification code for each of the parsed portions of the source code.

16. The non-transitory computer-readable medium of claim 15, further comprising instructions that cause the one or more processors to:
receive human feedback on the generated modification code; and
update the generated modification code based on the received human feedback.

17. The non-transitory computer-readable medium of claim 15, further comprising instructions that cause the one or more processors to:
access vulnerability reports from one or more databases; and
analyze the vulnerability reports to identify the one or more portions of the source code that require modification.

18. The non-transitory computer-readable medium of claim 15, further comprising instructions that cause the one or more processors to:
analyze the source code to identify one or more portions of the source code that require modification to address a security issue.

19. The non-transitory computer-readable medium of claim 18, further comprising instructions that cause the one or more processors to:
determine a severity score associated with the security issue, wherein the priority assigned to each of the identified portions of the source code is based on the severity score.

20. The non-transitory computer-readable medium of claim 15, further comprising instructions that cause the one or more processors to:
analyze the source code to identify one or more portions of the source code that require modification to comply with a predefined quality requirement.
